(19) United States
(12) Patent Application Publication
(10) Pub. No.: US 2026/0024204 A1
(43) Pub. Date: Jan. 22, 2026

(54) AUTOMATED METHOD FOR CLASSIFYING PROSTHESIS TYPE FROM THREE DIMENSIONAL ORAL DATA AND COMPUTER READABLE MEDIUM HAVING PROGRAM FOR PERFORMING THE METHOD

(71) Applicant: IMAGOWORKS INC., Seoul (KR)

(72) Inventors: Jinwoo LEE, Seoul (KR); Eunseo GWON, Gwangju-si (KR)

(73) Assignee: IMAGOWORKS INC., Seoul (KR)

(21) Appl. No.: 19/274,622

(22) Filed: Jul. 20, 2025

(30) Foreign Application Priority Data
Jul. 22, 2024 (KR) 10-2024-0096757
Sep. 5, 2024 (WO) PCT/KR2024/013409

(51) Int. Cl. G06T 7/00; G06V 10/25; G06V 10/40; G06V 10/764; G06V 10/82

(52) U.S. Cl. CPC G06T 7/0012; G06V 10/25; G06V 10/40; G06V 10/764; G06V 10/82; G06T 2207/10028; G06T 2207/30036

(57) ABSTRACT

An automated method for classifying a prosthesis type from a three dimensional oral data includes aligning a three dimensional oral data including tooth, extracting a feature for determining the prosthesis type to be used for the tooth from the three dimensional oral data which is aligned, combining the three dimensional oral data which is aligned with a feature data including the feature, and classifying the prosthesis type to be used for the tooth based on the three dimensional oral data which is aligned and the feature data.

### CROSS-REFERENCE TO RELATED APPLICATION(S)

This application claims priority under 35 U.S.C. § 119 to Korean Patent Application No. 10-2024-0096757, filed on Jul. 22, 2024 in the Korean Intellectual Property Office (KIPO) and International Patent Application No. PCT/KR2024/013409, filed on Sep. 5, 2024, the contents of which are herein incorporated by reference in their entireties.

### BACKGROUND

### 1. Field

Embodiments relate to an automated method for classifying a prosthesis type from a three dimensional oral data and a non-transitory computer-readable medium having program for performing the method. More particularly, embodiments relate to the automated method for classifying the prosthesis type from the three dimensional oral data using deep learning and the non-transitory computer-readable medium having program for performing the method.

### 2. Description of the Related Art

With advancement of artificial intelligence (AI) technology, research on explainable artificial intelligence (XAI) is actively being conducted to elucidate the operational principles of AI neural networks. A study explaining reasons for the prediction values of the artificial intelligence model among XAI studies uses a layer-wise relevance propagation (LRP) technique of which layer consists of the artificial intelligence.

The layer-wise relevance propagation technique is based on a principle that “sum of relevance scores of neurons belonging to each layer of an AI model is preserved across the layers.”, and the technique may operate a relevance score for each neuron in each layer by redistributing the prediction value of the AI model based on the weights assigned to each layer. That is, layer-wise relevance propagation technique is a form of backpropagation that traces backward from an output layer to an input layer, allowing a relative understanding of which parts of the input data contributed more to the model's final prediction value.

Meanwhile, three dimensional oral data refers to data scanned with a 3D scanner from subjects such as teeth and the oral cavity that have been modeled or reconstructed. The 3D oral data may be used for prosthetic or dental treatment of a patient. Recently, research has been conducted to utilize AI models, which apply various techniques including LRP, to automatically generate and learn data from a patient's 3D oral data that may be used for or assist in prosthetic or dental treatment.

### SUMMARY

Embodiments provide a method for automatically classifying a prosthesis type from a three dimensional oral data.

An automated method for classifying prosthesis type from a three dimensional oral data includes aligning a three dimensional oral data including a tooth, extracting a feature for determining the prosthesis type to be used for the tooth from the three dimensional oral data which is aligned, combining the three dimensional oral data, which is aligned, with a feature data including the feature and classifying the prosthesis type to be used for the tooth based on the three dimensional oral data which is aligned and the feature data.

In an embodiment, the extracting the feature may be performed by using a first artificial intelligence neural network. And the first artificial intelligence neural network may receive the three dimensional oral data which is aligned as an input, and may extract the feature by operating a contribution of each of a plurality of layers included in the first artificial intelligence neural network.

In an embodiment, an output of the first artificial intelligence neural network may be the feature data having a form of a heatmap which highlights a portion corresponding to the feature in the three dimensional oral data which is aligned.

In an embodiment, when the prosthesis type is a screw implant, the portion corresponding to the feature may be a boundary portion of a hole penetrating the tooth in a tooth axis direction.

In an embodiment, wherein when the prosthesis type is a bridge, the portion corresponding to the feature may be a connecting portion located between the tooth and a peripheral tooth adjacent to the tooth.

In an embodiment, wherein when the prosthesis type is an inlay, the portion corresponding to the feature may be an occlusal cavity formed on the tooth.

In an embodiment, the classifying the prosthesis type may be performed by using a second artificial intelligence neural network. And an input of the second artificial intelligence neural network may be a data in which the three dimensional oral data which is aligned and the feature data are combined with each other, and an output of the second artificial intelligence neural network may be the prosthesis type.

In an embodiment, while the classifying the prosthesis type is performed, the first artificial intelligence neural network may be trained to extract the feature from the three dimensional oral data which is aligned, and the second artificial intelligence neural network may be trained to classify the prosthesis type based on the three dimensional oral data which is aligned and the feature data.

In an embodiment, in the combining the three dimensional oral data which is aligned with the feature data, tensors included in the three dimensional oral data which is aligned and tensors included in the feature data may be combined in a channel direction.

In an embodiment, the aligning the three dimensional oral data may include extracting a region of interest from the three dimensional oral data and generating an alignment data by aligning the three dimensional oral data in the region of interest.

In an embodiment, the generating the alignment data may include extracting a point data from the three dimensional oral data in the region of interest, generating a multi-dimensional tree based on the point data, generating a three dimensional voxel based on the point data, searching for an adjacent point to the three dimensional voxel using the multi-dimensional tree, and determining a number of adjacent points as a value of the three dimensional voxel.

In an embodiment, in the generating the three dimensional voxel based on the point data, a size of the three dimensional voxel and a center of the three dimensional voxel may be determined using a maximum value of a vector coordinate included in the point data, a minimum value of the vector coordinate, and a size of the three dimensional oral data in the region of interest.

In an embodiment, in the determining the number of adjacent points as the value of the three dimensional voxel, a distance from the center of the three dimensional voxel to the adjacent point may be less than a half of the size of the three dimensional voxel.

In an embodiment, the generating the alignment data may include extracting a boundary data and a point data from the three dimensional oral data in the region of interest, generating an implicit mesh model based on the point data, generating a three dimensional binary array using the implicit mesh model, and aligning the three dimensional binary array.

In an embodiment, the generating the three dimensional binary array may include setting a dimension based on the boundary data and the point data using the implicit mesh model, partitioning the three dimensional oral data in the region of interest into voxels based on the dimension which is set, storing a shortest distance between meshes of the three dimensional oral data in the region of interest included in the voxel, generating an image array based on the shortest distance and the dimension, and converting the image array into the three dimensional binary array through a binarization.

In an embodiment, in the setting the dimension, a ratio of each axis may be set based on the boundary data using the implicit mesh model and the dimension may be set by multiplying an input size of the implicit mesh model by the ratio of the each axis.

In an embodiment, in the aligning the three dimensional binary array, the three dimensional binary array may be arranged at a center of tensors constituting the input size of the implicit mesh model using the implicit mesh model.

A non-transitory computer-readable storage medium having stored thereon program instructions, the program instructions executable by at least one hardware processor to align a three dimensional oral data including a tooth, extract a feature for determining a prosthesis type to be used for the tooth from the three dimensional oral data which is aligned, combine the three dimensional oral data which is aligned with a feature data including the feature, and classify the prosthesis type to be used for the tooth based on the three dimensional oral data which is aligned and the feature data.

In the automated method for classifying the prosthesis type from the three dimensional oral data according to embodiments of the present inventive concept, a feature of a tooth included in the three dimensional oral data may be automatically extracted by inputting the three dimensional oral data, and the prosthesis type to be used for the tooth may be automatically classified. Accordingly, when the prosthesis classification is manually performed, the analysis process of the individual tooth condition, which would otherwise take a long time, may be simplified. In addition, objective prosthesis classification may be enabled by suing an artificial intelligence neural network, thereby reducing the risk of misclassification of the prosthesis. Therefore, the automated method for classifying the prosthesis type from the three dimensional oral data may allow the prosthesis fabrication process for a patient to be conducted more efficiently and enable rapid treatment for the patient. Furthermore, by generating feature data to be used in the dental medical and research fields, the method may contribute to further advancements in a field of dental medicine and research.

### BRIEF DESCRIPTION OF THE DRAWINGS

Illustrative, non-limiting embodiments will be more clearly understood from the following detailed description in conjunction with the accompanying drawings.

FIG. 1 is a flowchart illustrating an automated method for classifying a prosthesis type from a three dimensional oral data according to an embodiment of the present inventive concept.

FIG. 2 is a diagram for explaining the automated method for classifying the prosthesis type from the three dimensional oral data of FIG. 1.

FIG. 3 is a flowchart illustrating an example of aligning the three dimensional oral data in a region of interest of FIG. 1 and generating the aligned data.

FIG. 4 is a diagram for explaining the aligning the three dimensional oral data in the region of interest and generating the aligned data of FIG. 3.

FIG. 5 is a diagram illustrating an example of a process in which extracting feature from the aligned data of FIG. 1 and generating feature data is performed, according to an input of the aligned data of FIG. 4.

FIG. 6 is a diagram illustrating another example of a process in which extracting feature from the aligned data of FIG. 1 and generating feature data is performed, according to an input of the aligned data of FIG. 4.

FIG. 7 is a diagram illustrating still another example of a process in which extracting feature from the aligned data of FIG. 1 and generating feature data is performed, according to an input of the aligned data of FIG. 4.

FIG. 8 is a diagram for explaining combining the aligned data of FIG. 1 and the feature and classifying the prosthesis type to be used for the tooth.

FIG. 9 is a flowchart illustrating another example of aligning the three dimensional oral data in a region of interest of FIG. 1 and generating aligned data.

FIG. 10 is a flow chart illustrating generating a three dimensional binary array using an implicit mesh model of FIG. 9.

FIG. 11 is a diagram for explaining aligning the three dimensional oral data in the region of interest of FIG. 9 and generating the aligned data.

FIG. 12 is a diagram illustrating an example of a process in which extracting feature from the aligned data of FIG. 1 and generating feature data is performed, according to an input of the aligned data of FIG. 11.

FIG. 13 is a diagram illustrating another example of a process in which extracting feature from the aligned data of FIG. 1 and generating feature data is performed, according to an input of the aligned data of FIG. 11.

FIG. 14 is a diagram illustrating still another example of a process in which extracting feature from the aligned data of FIG. 1 and generating feature data is performed, according to an input of the aligned data of FIG. 11.

### DETAILED DESCRIPTION OF THE EMBODIMENTS

The specific structural or functional descriptions of embodiments of the present inventive concept disclosed herein are merely illustrated for the purpose of explaining the embodiments of the present inventive concept. The embodiments of the present inventive concept may be implemented in various forms and should not be construed as being limited to the embodiments described herein.

The present inventive concept is capable of various modifications and having various forms. Specific embodiments are illustrated in the drawings and described in detail in the text. However, this is not intended to limit the present inventive concept to the specific disclosed forms, and it should be understood to include all modifications, equivalents, and substitutes that fall within the spirit and technical scope of the present inventive concept.

Terms such as first and second may be used to describe various components, but the components should not be limited by these terms. These terms may be used merely to distinguish one component from another component. For example, a first component may be referred to as a second component without departing from the scope of the present inventive concept, and likewise, the second component may also be referred to as the first component.

When a component is referred to as being “connected” or “coupled” to another component, it may be directly connected or coupled to the other component, or there may be another component in between. On the other hand, when a component is referred to as being “directly connected” or “directly coupled” to another component, it should be understood that there is no other component in between. Other expressions used to describe the relationships between components, such as “between” and “immediately between” or “adjacent to” and “directly adjacent to,” should be interpreted in the same manner.

The terminology used in this application is merely for the purpose of describing particular embodiments and is not intended to limit the present inventive concept. Unless explicitly stated otherwise, the singular expressions include the plural expressions as well. In this application, the terms such as “include” or “have” are intended to designate that the stated features, numbers, steps, operations, components, parts, or combinations thereof exist, and are not intended to preclude the possibility that one or more other features, numbers, steps, operations, components, parts, or combinations thereof may also exist or be added.

Unless otherwise defined, all terms used herein including technical or scientific terms have the same meaning as commonly understood by one of ordinary skill in the art to which this inventive concept belongs. Terms defined in commonly used dictionaries are to be interpreted as having meanings consistent with their use in the relevant technical field and should not be interpreted in an idealized or overly formal sense unless expressly so defined in this application.

Meanwhile, in cases where an embodiment may be implemented otherwise, functions or operations specified in a specific block may occur in an order different from that specified in the flowchart. For example, two successive blocks may in fact be executed substantially simultaneously, or the blocks may sometimes be executed in reverse order depending on the functions or operations involved.

Hereinafter, preferred embodiments of the present inventive concept will be described in more detail with reference to the accompanying drawings. In the drawings, the same reference numerals denote the same components, and repeated descriptions of the same components will be omitted.

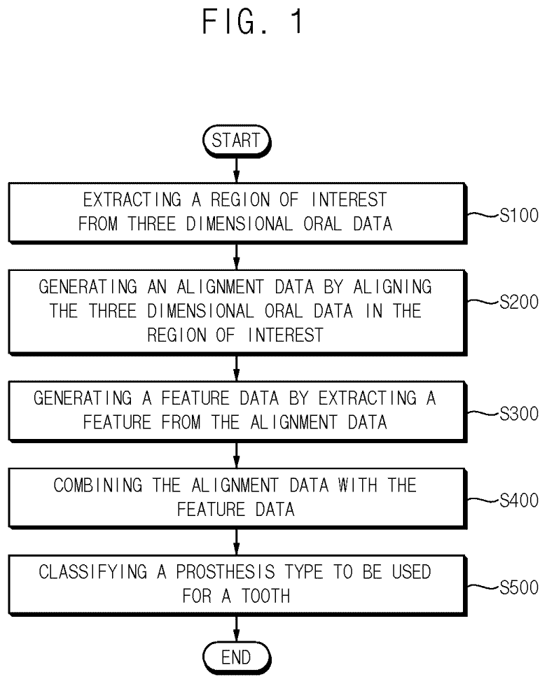

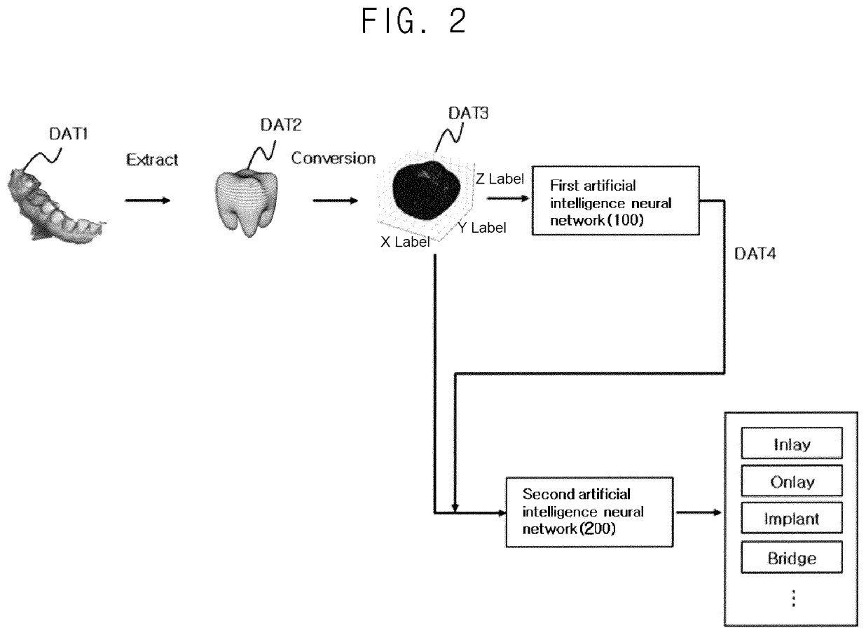

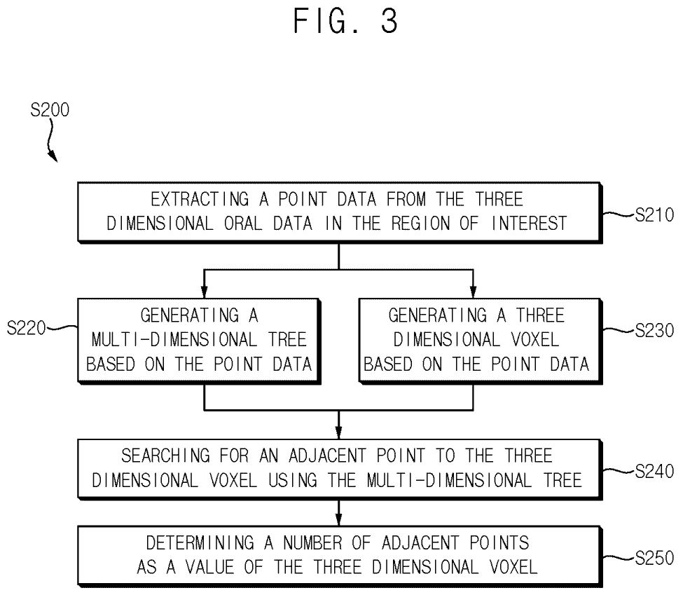

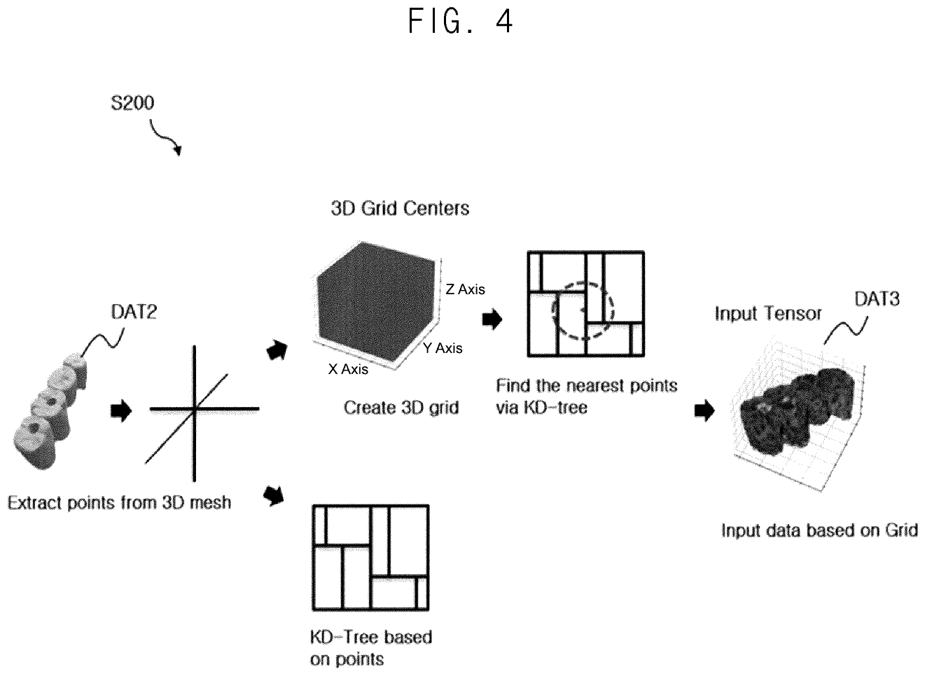

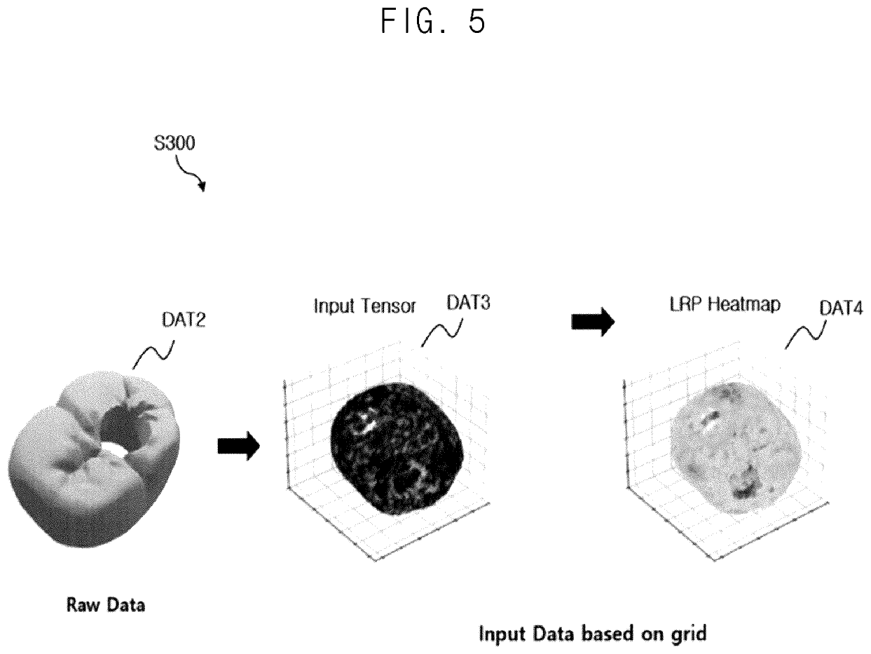

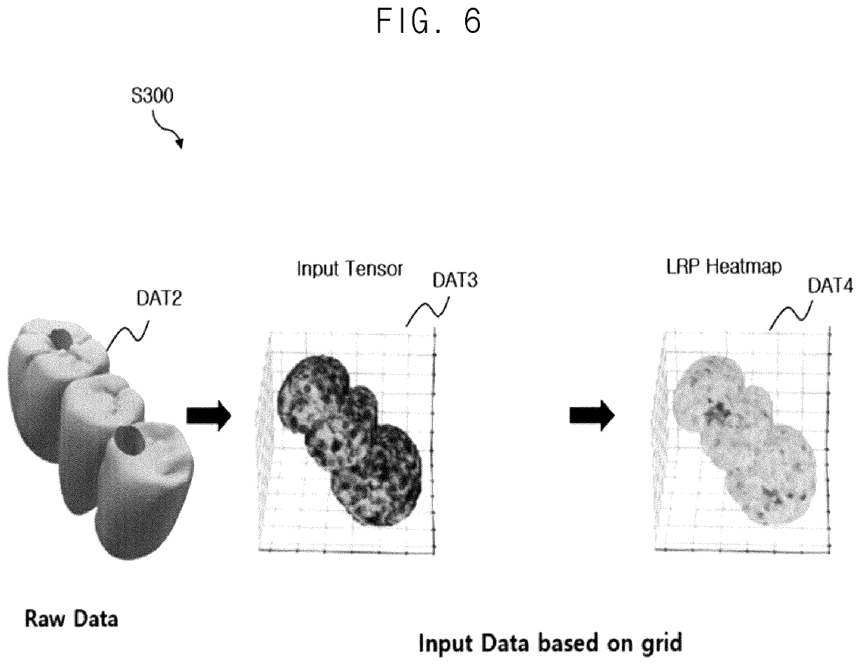

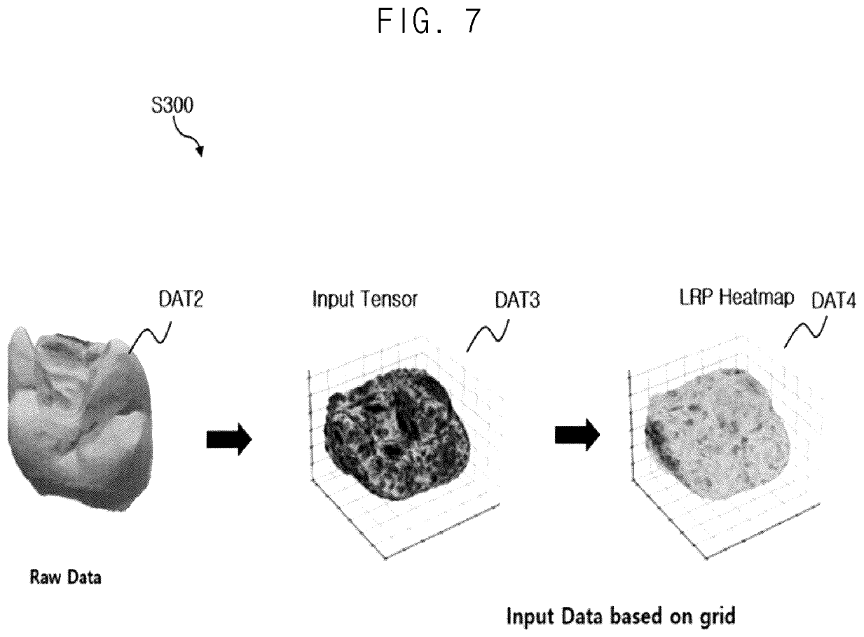

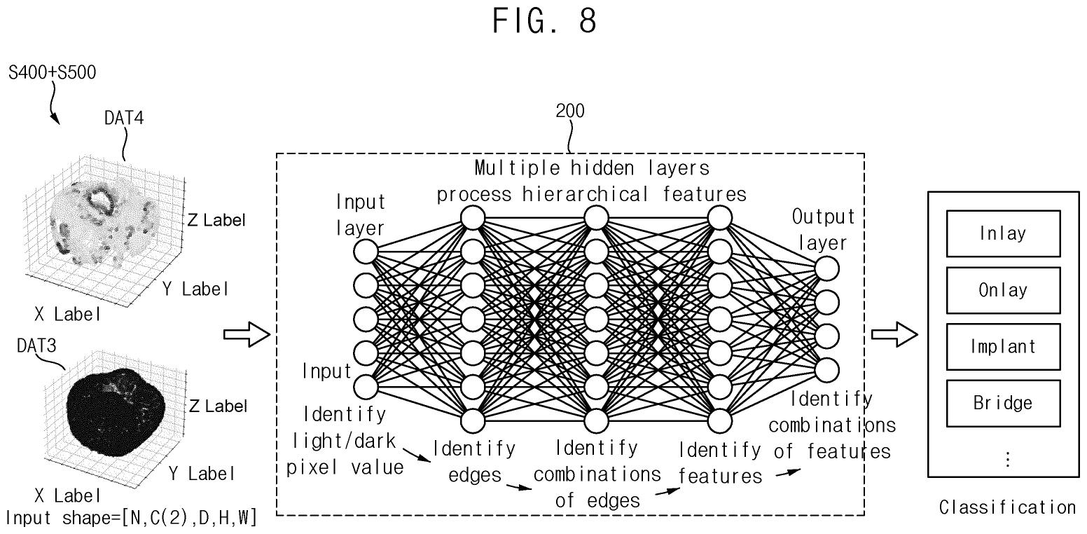

FIG. 1 is a flowchart illustrating an automated method for classifying a prosthesis type from a three dimensional oral data according to an embodiment of the present inventive concept. FIG. 2 is a diagram for explaining the automated method for classifying the prosthesis type from the three dimensional oral data of FIG. 1. FIG. 3 is a flowchart illustrating an example of aligning the three dimensional oral data in a region of interest of FIG. 1 and generating the aligned data. FIG. 4 is a diagram for explaining the aligning the three dimensional oral data in the region of interest and generating the aligned data of FIG. 3. FIG. 5 is a diagram illustrating an example of a process in which extracting feature from the aligned data of FIG. 1 and generating feature data is performed, according to an input of the aligned data of FIG. 4. FIG. 6 is a diagram illustrating another example of a process in which extracting feature from the aligned data of FIG. 1 and generating feature data is performed, according to an input of the aligned data of FIG. 4. FIG. 7 is a diagram illustrating still another example of a process in which extracting feature from the aligned data of FIG. 1 and generating feature data is performed, according to an input of the aligned data of FIG. 4. FIG. 8 is a diagram for explaining combining the aligned data of FIG. 1 and the feature and classifying the prosthesis type to be used for the tooth.

Referring to FIGS. 1, 2, 3, 4, 5, 6, 7, and 8, an automated method for classifying a prosthesis type from a three dimensional oral data according to an embodiment of the present inventive concept may include extracting a region of interest from three dimensional oral data DAT1 S100, generating an alignment data DAT3 by aligning the three dimensional oral data in the region of interest (hereinafter, region of interest data DAT2) S200, generating a feature data DAT4 by extracting a feature from the alignment data DAT3 S300, combining the alignment data DAT3 with the feature data DAT4 S400, and classifying a prosthesis type to be used for a tooth S500.

The automated method for classifying the prosthesis type from the three dimensional oral data may be performed by a computing device.

In an embodiment, the three dimensional oral data DAT1 may be data obtained by scanning the patient's oral cavity with a three dimensional scanner. In an embodiment, the three dimensional oral data DAT1 may include an arch comprising a maxilla and a mandible, and at least one tooth arranged according to the shape of the arch. For example, the arch may have an arch shape, and the teeth may include natural teeth and teeth prepared for treatment. In addition, the three dimensional oral data DAT1 may include an abutment artificially implanted for implants. However, a type and dimension of the three dimensional oral data DAT1 according to embodiments of the present inventive concept may not be limited thereto, and the three dimensional oral data DAT1 may also include various types of medical image data for treatment such as CT or MRI.

In an embodiment, the three dimensional oral data DAT1 may be three dimensional mesh data. For example, the three dimensional oral data DAT1 refers to data obtained by scanning teeth and oral structures or replicas thereof reconstructed by a three dimensional scanner. For example, the three dimensional oral data DAT1 may be mesh data comprising three dimensional vertices and triangular or rectangular faces formed by connecting the vertices. The three dimensional oral data DAT1 may be image data captured by a three dimensional scanner. A file extension of the three dimensional oral scan data may not be limited, and the file extension may be for example, one among ply, obj, or stl. However, a form of the three dimensional oral data DAT1 according to embodiments of the present inventive concept may not be limited thereto and may be collected data in various forms such as tensors or arrays.

In the extracting the region of interest from the three dimensional oral data DAT1 S100, the region of interest may be a portion extracted from the three dimensional oral data DAT1. For example, the region of interest may be a region including the tooth included in the three dimensional oral data DAT1. In an embodiment, one region of interest may include one tooth included in the three dimensional oral data DAT1. In another embodiment, one region of interest may include multiple teeth included in the three dimensional oral data DAT1. In an embodiment, the region of interest may further include a portion of the arch connected to the tooth or teeth. However, the region of interest according to embodiments of the present inventive concept may not be limited thereto and may be an extracted region necessary for performing subsequent steps (the generating the alignment data DAT3 by aligning the region of interest data DAT2 S200, the generating the feature data DAT4 by extracting the feature from the alignment data DAT3 S300, the combining the alignment data DAT3 with the feature data DAT4 S400, and the classifying the prosthesis type to be used for the tooth S500) among regions in the three dimensional oral data DAT1.

In an embodiment, the extracting the region of interest from the three dimensional oral data DAT1 S100 may be automatically performed by an artificial intelligence neural network.

In another embodiment, the extracting the region of interest from the three dimensional oral data DAT1 S100 may be manually performed by a user. In an embodiment, in the extracting the region of interest from the three dimensional oral data DAT1 S100, a process of extracting a region in the three dimensional oral data DAT1 may be repeatedly performed such at least one tooth is included in the region of interest. After the region of interest is extracted from the three dimensional oral data DAT1, the region of interest data DAT2 may be generated.

In the generating alignment data DAT3 by aligning the region of interest data DAT2 S200, the region of interest data DAT2 may be transformed into a data form for performing the generating feature data DAT4 by extracting features from the alignment data DAT3. For example, in the generating alignment data DAT3 by aligning the region of interest data DAT2 S200, a data alignment process such as an axis transformation may be performed on the region of interest data DAT2 and the alignment data DAT3 may be generated.

The generating alignment data DAT3 by aligning the region of interest data DAT2 S200 may include extracting a point data from the region of interest data DAT2 S210, generating a multi-dimensional tree based on the point data S220, generating a three dimensional voxel based on the point data S230, searching for an adjacent point to the three dimensional voxel using the multi-dimensional tree S240, and determining a number of adjacent points as a value of the three dimensional voxel S250.

In the extracting the point data from the region of interest data DAT2 S210, the point data of each object included in the region of interest data DAT2 may be extracted. For example, the point data of each of three dimensional meshes included in the region of interest data DAT2 may be extracted. In the generating the multi-dimensional tree based on the point data S220, a space for multi-dimensional searching may be mapped using the point data extracted. In an embodiment, the generating the multi-dimensional tree based on the point data S220 may be a constructing a k-d tree using the point data.

In the generating the three dimensional voxel based on the point data S230, the three dimensional voxel may be a unit cell for partitioning the region of interest data DAT2 into a three dimensional grid. In an embodiment, in the generating the three dimensional voxel based on the point data S230, arrangement and size of the three dimensional voxel may be determined using the point data. For example, in the generating the three dimensional voxel based on the point data S230, a maximum value of a vector coordinate included in the point data, a minimum value of the vector coordinate, and a size of the region of interest data DAT2 may be used to determine the size of the three dimensional voxel and a center of the three dimensional voxel. Specifically, the maximum value of the vector coordinate may include a maximum value for each of three axes (e.g., x-axis, y-axis, z-axis), and the minimum value of the vector coordinate may include a minimum values for each of the three axes. After determining the size of the three dimensional voxel and center of the three dimensional voxel, a plurality of three dimensional voxels partitioning the region of interest data DAT2 entirely may be generated.

In an embodiment, the generating the multi-dimensional tree based on the point data S220 and the generating the three dimensional voxel based on the point data S230 may be performed simultaneously. However, an order of performing the generating the multi-dimensional tree based on the point data S220 and the generating the three dimensional voxel based on the point data S230 according to embodiments of the present inventive concept may not be limited thereto, and the multi-dimensional tree may be generated before or after generating the three dimensional voxel.

In the searching for the adjacent point to the three dimensional voxel using the multi-dimensional tree S240, the points (e.g., the adjacent point) that satisfy a set criterion based on one of the three dimensional voxel may be searched by using a specific algorithm. In an embodiment, in the searching for the adjacent point to the three dimensional voxel using the multi-dimensional tree S240, a distance from the center of the three dimensional voxel to the adjacent point may be less than a half of the size of the three dimensional voxel. Specifically, the points satisfying the set criterion may be located at a distance less than a half of the voxel size from the center of the three dimensional voxel. Subsequently, in the determining a number of the adjacent points as a value of the three dimensional voxel S250, the number of the searched points may be set as the value of the corresponding three dimensional voxel.

In the searching for the adjacent point to the three dimensional voxel using the multi-dimensional tree S240 and the determining a number of the adjacent points as a value of the three dimensional voxel S250, a process of searching for a number of the adjacent points and setting the value to the three dimensional voxel may be repeated until values are set to each of all three dimensional voxels. Using the value set to the three dimensional voxel, the alignment data DAT3 may be finally generated. In other words, the alignment data DAT3 generated may be grid-based aligned data (e.g., the three dimensional voxel) through the generating alignment data DAT3 by aligning the region of interest data DAT2 S200 of FIG. 3. However, the type of the alignment data DAT3 according to embodiments of the present inventive concept may not be limited thereto and may have various types of data.

The generating the feature data DAT4 by extracting the feature from the alignment data DAT3 may be performed using a first artificial intelligence neural network 100. An input to the first artificial intelligence neural network 100 may be the alignment data DAT3. An output of the first artificial intelligence neural network 100 may be the feature data DAT4. The alignment data DAT3 may be aligned three dimensional oral data DAT1, and the feature data DAT4 may be data including the feature extracted from the alignment data DAT3.

In an embodiment, the first artificial intelligence neural network 100 may be a deep learning-based artificial intelligence neural network using a layer-wise relevance propagation (LRP) technique. For example, the first artificial intelligence neural network 100 may receive the alignment data DAT3 as the input and extract the feature by operating a contribution of each of a plurality of layers included in the first artificial intelligence neural network 100.

In an embodiment, the feature data DAT4, which is the output of the first artificial intelligence neural network 100, may be in a form of a heatmap. For example, the feature data DAT4 may emphasize a portion corresponding to the feature in the alignment data DAT3. However, the feature data DAT4 according to embodiments of the present inventive concept may have various forms except for the heatmap. The feature may include data or value for determining the prosthesis type to be used for the tooth included in the three dimensional oral data DAT1. In addition, the portion corresponding to the feature may be a region which is differently emphasized depending on the prosthesis type.

In an embodiment, when the prosthesis type to be used for the tooth is a screw implant as illustrated in FIG. 5, the portion corresponding to the feature may be a boundary portion of a hole penetrating the tooth in a tooth axis direction. In an embodiment, when the prosthesis type is a bridge as shown in FIG. 6, the portion corresponding to the feature may be a connecting portion located between the tooth and a peripheral tooth adjacent to the tooth. In an embodiment, when the prosthesis type is an inlay as shown in FIG. 7, the portion corresponding to the feature may be an occlusal cavity formed in the tooth. However, the prosthesis type according to embodiments of the present inventive concept may not be limited thereto and may include various types such as an onlay and/or the like. In addition, the portion corresponding to the feature may not be limited thereto and may vary depending on the prosthesis type, thus corresponding to various portions of the tooth.

In the combining the alignment data DAT3 with the feature data DAT4 S400, the alignment data DAT3 and the feature data DAT4 may be merged. In an embodiment, in the combining the alignment data DAT3 with the feature data DAT4 S400, tensors included in the alignment data DAT3 and tensors included in the feature data DAT4 may be combined in a channel direction. For example, the alignment data DAT3 may include a three dimensional tensor having values for depth (D), height (H), and width (W). In addition, the feature data DAT4 may include a three dimensional tensor having values for depth (D), height (H), and width (W). In the combining the alignment data DAT3 with the feature data DAT4 S400, the alignment data DAT3 and the feature data DAT4 may be combined and may be generate as a combined data having a four-dimensional tensor by overlapping values for depth (D), height (H), and width (W). However, the number of dimensions of the combined data according to embodiments of the present inventive concept may not be limited thereto.

The classifying the prosthesis type to be used for the tooth S500 may be performed using a second artificial intelligence neural network 200. An input to the second artificial intelligence neural network 200 may be the alignment data DAT3 and the feature, and an output of the second artificial intelligence neural network 200 may be the prosthesis type. For example, the input to the second artificial intelligence neural network 200 may be the combined data obtained by combining the alignment data DAT3 with the feature data DAT4.

In an embodiment, the second artificial intelligence neural network 200 may include a classification model. For example, the classification model may include ResNet, Vit, and the like. However, a type of the second artificial intelligence neural network 200 according to embodiments of the present inventive concept may not be limited thereto.

The second artificial intelligence neural network 200 may classify the prosthesis type corresponding to the input combined data through computation processes such as convolution using a plurality of layers. In an embodiment, the prosthesis type corresponding to the output of the second artificial intelligence neural network 200 may include inlay, onlay, implant, bridge, and the like. The screw implant described with reference to FIG. 5 may be classified as an implant. However, the prosthesis type according to embodiments of the present inventive concept may not be limited thereto.

In an embodiment, while the classifying the prosthesis type to be used for the tooth S500 is performed, the first artificial intelligence neural network 100 may train a process of extracting the features from the alignment data DAT3. In addition, while the classifying the prosthesis type to be used for the tooth S500 is performed, the second artificial intelligence neural network 200 may train a process of classifying the prosthesis type based on the alignment data DAT3 and the feature. That is, while the classifying the prosthesis type to be used for the tooth S500 is performed, the second artificial intelligence neural network 200 may train a process of classifying the prosthesis type using the combined data.

As described above, in the automated method for classifying the prosthesis type from the three dimensional oral data, the three dimensional oral data DAT1 is input, the feature of the tooth included in the three dimensional oral data DAT1 is automatically extracted, and the prosthesis type to be used for the tooth to be automatically classified. Accordingly, when a prosthesis classification is manually performed, an analysis process of the individual tooth condition, which takes a long time, may be simplified. In addition, by using an artificial intelligence neural network, objective prosthesis classification may be enabled, thereby reducing a risk of misclassification of the prosthesis. Therefore, through the automated method for classifying the prosthesis type from the three dimensional oral data, the prosthesis manufacturing process for a patient may be efficiently carried out, and rapid treatment may be provided to the patient. In addition, as the feature data DAT4 to be used in dental treatment and research is generated, dental medical and research fields may be further advanced.

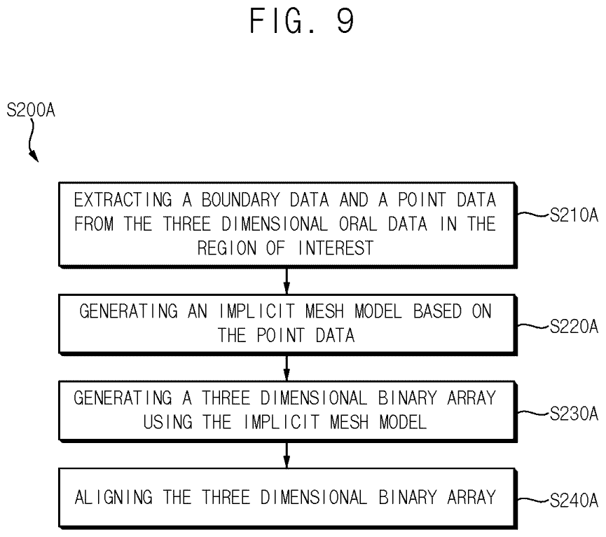

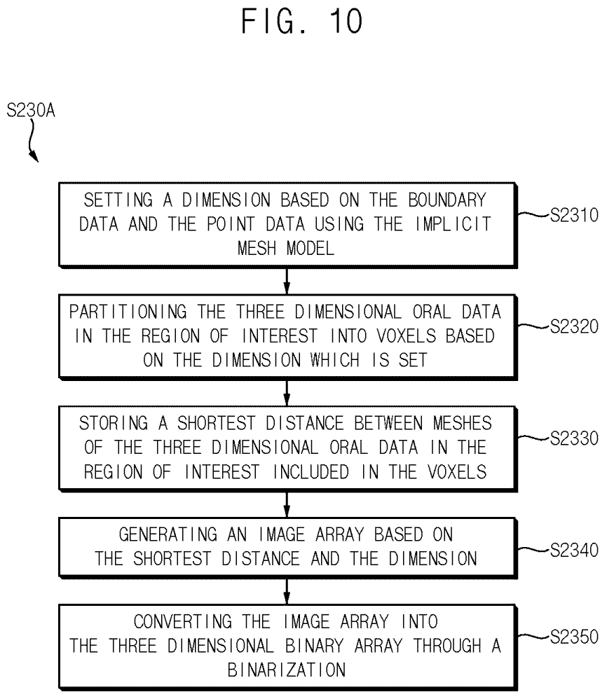

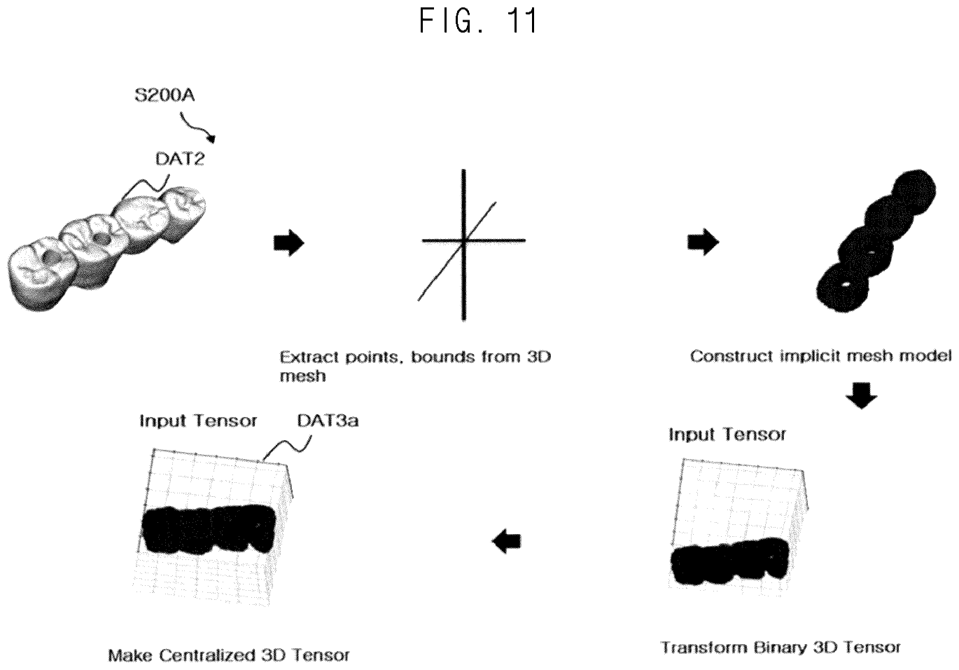

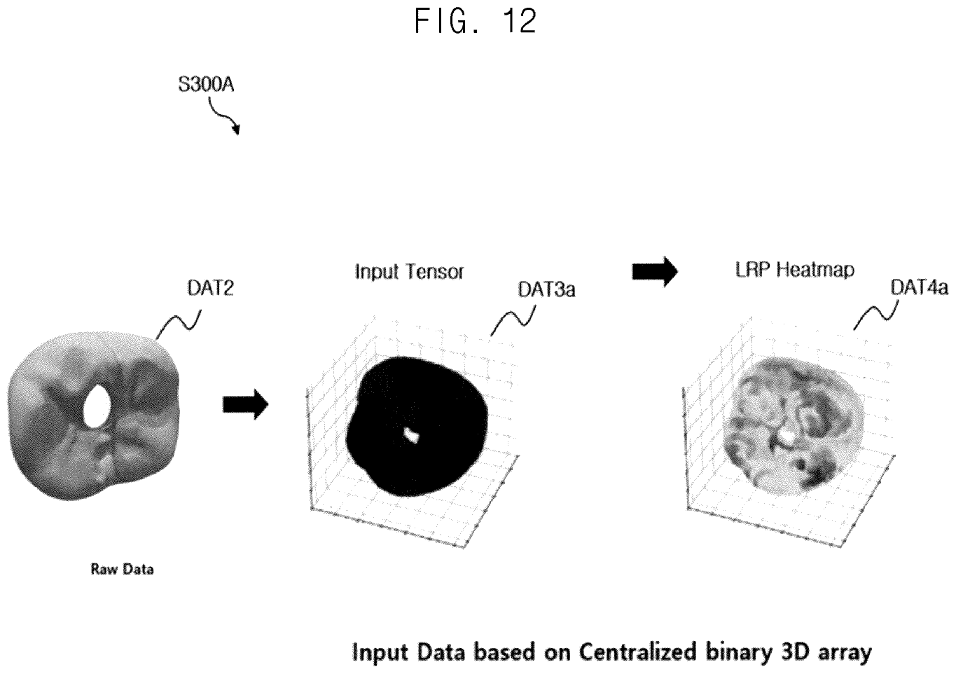

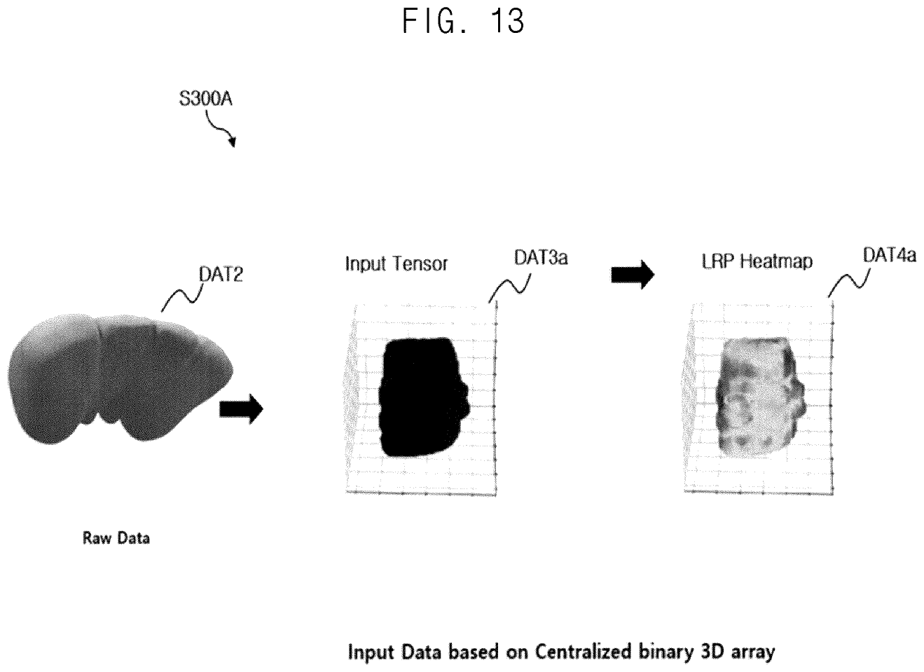

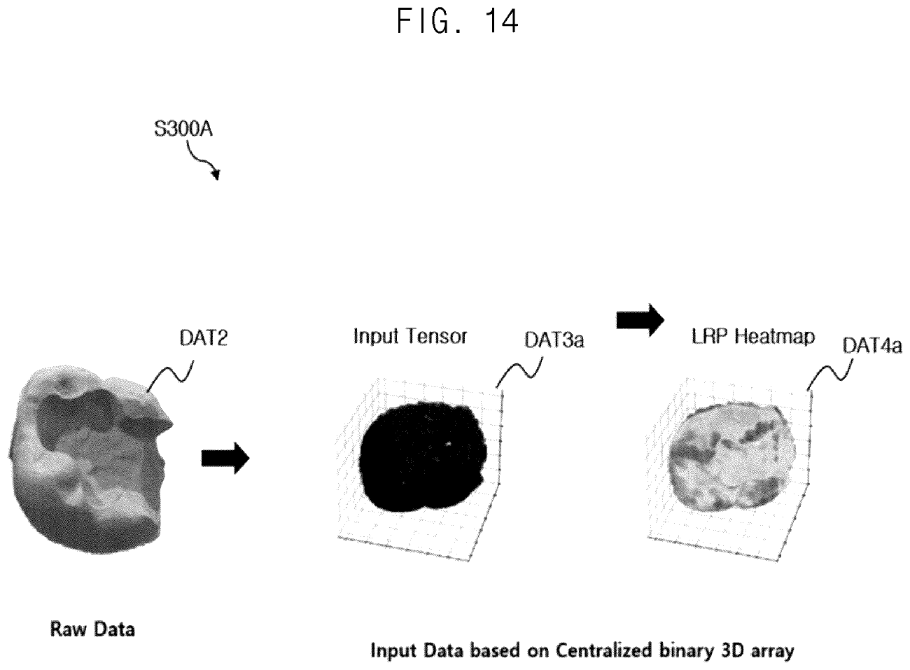

FIG. 9 is a flowchart illustrating another example of aligning the three dimensional oral data in a region of interest of FIG. 1 and generating aligned data. FIG. 10 is a flow chart illustrating generating a three dimensional binary array using an implicit mesh model of FIG. 9. FIG. 11 is a diagram for explaining aligning the three dimensional oral data in the region of interest of FIG. 9 and generating the aligned data. FIG. 12 is a diagram illustrating an example of a process in which extracting feature from the aligned data of FIG. 1 and generating feature data is performed, according to an input of the aligned data of FIG. 11. FIG. 13 is a diagram illustrating another example of a process in which extracting feature from the aligned data of FIG. 1 and generating feature data is performed, according to an input of the aligned data of FIG. 11. FIG. 14 is a diagram illustrating still another example of a process in which extracting feature from the aligned data of FIG. 1 and generating feature data is performed, according to an input of the aligned data of FIG. 11.

Generating a feature data DAT4a by extracting the feature from the alignment data DAT3a. as described with reference to FIGS. 12, 13, and 14, may be substantially a same or similar to the generating the feature data DAT4 by extracting the feature from the alignment data DAT3, as described with reference to FIGS. 5, 6, and 7, except that an input is the alignment data DAT3a and an output is the feature data DAT4a. Hereinafter, overlapping content with the description referring to FIGS. 5, 6, and 7 will be omitted or simplified.

Referring to FIGS. 9, 10, 11, 12, 13, and 14, the automated method for classifying a prosthesis type from the three dimensional oral data may include generating an alignment data DAT3a by aligning the three dimensional oral data in a region of interest (hereinafter, the region of interest data DAT2) S200A. The generating the alignment data DAT3a by aligning the region of interest data DAT2 S200A may include extracting a boundary data and a point data from the region of interest data DAT2, generating an implicit mesh model based on the point data S220A, generating a three dimensional binary array using the implicit mesh model S230A, and aligning the three dimensional binary array S240A.

The generating the three dimensional binary array using the implicit mesh model S230A may include setting a dimension based on the boundary data and the point data using the implicit mesh model S2310, partitioning the region of interest data DAT2 into voxels based on the dimension which is set S2320, storing a shortest distance between meshes of the region of interest data DAT2 included in the voxels S2330, generating an image array based on the shortest distance and the dimension S2340, and converting the image array into the three dimensional binary array through a binarization S2350.

In an embodiment, the implicit mesh model may be a model that slices the region of interest data DAT2 of a three dimensional mesh in one of an axial direction to generate a cross-sectional image. In the generating the alignment data DAT3a by aligning the region of interest data DAT2 S200A, parameters for generating the implicit mesh model may be set. For example, the parameters may relate to shell size, padding, and the like.

In the setting the dimension based on the boundary data and the point data using the implicit mesh model S2310, the dimension may be set by multiplying the input size of the implicit mesh model with a ratio of each axis (e.g., x-axis, y-axis, z-axis). Specifically, based on the boundary data of the region of interest data DAT2, the ratio of the each axis may be set with respect to an axis having a longest length, and the dimension may be set by multiplying the each ratio of the each axis and the input size of the model. In an embodiment, the input size of the implicit mesh model may be fixed. For example, the input size may be 64*64*64. However, a setting the input size and the dimensions may be exemplary, and the implicit mesh model according to embodiments of the present inventive concept may not be limited thereto.

In the partitioning the region of interest data DAT2 into voxels based on the dimension which is set S2320, voxels which are three dimensional grids for the dimension which is set may be generated based on the boundary data. The voxels may partition the region of interest data DAT2 into multiple areas.

In storing the shortest distance between meshes of the region of interest data DAT2 included in the voxels S2330, the shortest distance between boundary surfaces of each mesh constituting the region of interest data DAT2 in each voxel may be operated. If the shortest distance between the boundary surfaces of the each mesh exceeds a preset maximum value, the maximum value may be stored in the voxel. For example, the maximum value may be a size of the voxel. However, the process of storing the shortest distance according to embodiments of the present inventive concept may not be limited thereto.

In the generating the image array based on the shortest distance and the dimension S2340, an image array having a size corresponding to the dimensions may be generated. In the converting the image array into the three dimensional binary array through the binarization S2350, values arbitrarily stored in empty voxels may be removed, and a binarization process may be performed on the image array to represent the mesh shape.

In the aligning the three dimensional binary array S240A, the three dimensional binary array may be arranged at a center of tensors having the input size using the implicit mesh model. Accordingly, the three dimensional binary array having a variable size may be transformed into a fixed-size three dimensional tensor.

After the aligning the three dimensional binary array S240A is performed, the alignment data DAT3a may be generated using the aligned three dimensional binary array. Unlike a process of generating the alignment data DAT3 of FIG. 4 using a multi-dimensional tree, a generation of the alignment data DAT3a using the three dimensional binary array may not result in missing values in specific cells, allowing data to be evenly distributed across the cells.

In the generating the feature data DAT4a by extracting features from the alignment data DAT3a S300, the feature data DAT4a may be generated from the alignment data DAT3a based on the three dimensional binary array. The feature data DAT4a may be substantially a same as the feature data DAT4 of FIGS. 5, 6, and 7. For example, the feature data DAT4a may be in the form of a heatmap that emphasizes the extracted features from the alignment data DAT3a based on the three dimensional binary array.

According to an embodiment of the present inventive concept, a non-transitory computer-readable recording medium on which a program for executing the automated method for classifying the prosthesis type from the three dimensional oral data as described in the above embodiments is recorded may be provided. The above-described method may be implemented as a program executable on a computer, and may be realized on a general-purpose digital computer that operates the program using a computer-readable medium. In addition, the structure of the data used in the above-described method may be recorded on the computer-readable medium by various means. The computer-readable medium may include program instructions, data files, data structures, and the like, either alone or in combination. The program instructions recorded on the medium may be those specifically designed and configured for the present inventive concept, or may be program instructions that are publicly known and usable by those skilled in the field of computer software. Examples of the computer-readable recording medium include magnetic media such as hard disks, floppy disks, and magnetic tapes, optical recording media such as CD-ROMs and DVDs, magneto-optical media such as floptical disks, and hardware devices such as ROM, RAM, and flash memory, which are specifically configured to store and execute program instructions. Examples of the program instructions include not only machine language code generated by compilers, but also high-level language code that may be executed by computers using interpreters and the like. The above-mentioned hardware devices may be configured to operate as one or more software modules for performing operations of the present inventive concept.

In addition, the above-described method for automatically classifying a prosthesis type from the three dimensional oral data may also be implemented in the form of a computer program or application executed by a computer and stored on a recording medium.

The present inventive concept relates to the automated method for classifying the prosthesis type from three dimensional oral data and the non-transitory computer readable medium having the program recorded for performing the method, and the method and the medium may reduce the effort and time required for prosthesis fabrication and may improve the accuracy and productivity of the prosthesis.

While the above has been described with reference to exemplary embodiments of the present inventive concept, it will be understood by those skilled in the art that the present inventive concept may be variously modified and changed without departing from the spirit and scope of the present inventive concept as defined in the following claims.

What is claimed is:

1. An automated method for classifying a prosthesis type from a three dimensional oral data comprising:
aligning a three dimensional oral data including a tooth;
extracting a feature for determining the prosthesis type to be used for the tooth from the three dimensional oral data which is aligned;
combining the three dimensional oral data, which is aligned, with a feature data including the feature; and
classifying the prosthesis type to be used for the tooth based on the three dimensional oral data which is aligned and the feature data.

2. The method of claim 1, wherein the extracting the feature is performed by using a first artificial intelligence neural network, and
wherein the first artificial intelligence neural network receives the three dimensional oral data which is aligned as an input, and extracts the feature by operating a contribution of each of a plurality of layers included in the first artificial intelligence neural network.

3. The method of claim 2, wherein an output of the first artificial intelligence neural network is the feature data having a form of a heatmap which highlights a portion corresponding to the feature in the three dimensional oral data which is aligned.

4. The method of claim 3, wherein when the prosthesis type is a screw implant, the portion corresponding to the feature is a boundary portion of a hole penetrating the tooth in a tooth axis direction.

5. The method of claim 3, wherein when the prosthesis type is a bridge, the portion corresponding to the feature is a connecting portion located between the tooth and a peripheral tooth adjacent to the tooth.

6. The method of claim 3, wherein when the prosthesis type is an inlay, the portion corresponding to the feature is an occlusal cavity formed on the tooth.

7. The method of claim 2, wherein the classifying the prosthesis type is performed by using a second artificial intelligence neural network, and
wherein an input of the second artificial intelligence neural network is a data in which the three dimensional oral data which is aligned and the feature data are combined with each other, and an output of the second artificial intelligence neural network is the prosthesis type.

8. The method of claim 7, wherein while the classifying the prosthesis type is performed,
the first artificial intelligence neural network is trained to extract the feature from the three dimensional oral data which is aligned, and
the second artificial intelligence neural network is trained to classify the prosthesis type based on the three dimensional oral data which is aligned and the feature data.

9. The method of claim 1, wherein, in the combining the three dimensional oral data which is aligned with the feature data,
tensors included in the three dimensional oral data which is aligned and tensors included in the feature data are combined in a channel direction.

10. The method of claim 1, wherein the aligning the three dimensional oral data includes:
extracting a region of interest from the three dimensional oral data; and
generating an alignment data by aligning the three dimensional oral data in the region of interest.

11. The method of claim 10, wherein the generating the alignment data includes:
extracting a point data from the three dimensional oral data in the region of interest;
generating a multi-dimensional tree based on the point data;
generating a three dimensional voxel based on the point data;
searching for an adjacent point to the three dimensional voxel using the multi-dimensional tree; and
determining a number of adjacent points as a value of the three dimensional voxel.

12. The method of claim 11, wherein, in the generating the three dimensional voxel based on the point data,
a size of the three dimensional voxel and a center of the three dimensional voxel are determined using a maximum value of a vector coordinate included in the point data, a minimum value of the vector coordinate, and a size of the three dimensional oral data in the region of interest.

13. The method of claim 12, wherein, in the determining the number of adjacent points as the value of the three dimensional voxel,
a distance from the center of the three dimensional voxel to the adjacent point is less than a half of the size of the three dimensional voxel.

14. The method of claim 10, wherein the generating the alignment data includes:
extracting a boundary data and a point data from the three dimensional oral data in the region of interest;
generating an implicit mesh model based on the point data;
generating a three dimensional binary array using the implicit mesh model; and
aligning the three dimensional binary array.

15. The method of claim 14, wherein the generating the three dimensional binary array includes:
setting a dimension based on the boundary data and the point data using the implicit mesh model;
partitioning the three dimensional oral data in the region of interest into voxels based on the dimension which is set;
storing a shortest distance between meshes of the three dimensional oral data in the region of interest included in the voxels;
generating an image array based on the shortest distance and the dimension; and
converting the image array into the three dimensional binary array through a binarization.

16. The method of claim 15, wherein, in the setting the dimension,
a ratio of each axis is set based on the boundary data using the implicit mesh model, and
the dimension is set by multiplying an input size of the implicit mesh model by the ratio of the each axis.

17. The method of claim 16, wherein, in the aligning the three dimensional binary array, the three dimensional binary array is arranged at a center of tensors constituting the input size of the implicit mesh model using the implicit mesh model.

18. A non-transitory computer-readable storage medium having stored thereon program instructions, the program instructions executable by at least one hardware processor to:
align a three dimensional oral data including a tooth;
extract a feature for determining a prosthesis type to be used for the tooth from the three dimensional oral data which is aligned;
combine the three dimensional oral data which is aligned with a feature data including the feature; and
classify the prosthesis type to be used for the tooth based on the three dimensional oral data which is aligned and the feature data.
